(19) United States
(12) Patent Application Publication
(10) Pub. No.: US 2025/0217877 A1
(43) Pub. Date: Jul. 3, 2025

(54) AI-DRIVEN REAL-TIME AUCTION SYSTEM FOR LIVE EVENTS WITH DYNAMIC PRICING, SENTIMENT ANALYSIS AND FRAUD DETECTION

(71) Applicant: RAGHU K PARA, WINDSOR (CA)

(72) Inventor: RAGHU K PARA, WINDSOR (CA)

(21) Appl. No.: 19/082,216

(22) Filed: Mar. 18, 2025

(51) Int. Cl. G06Q 30/08; G06F 40/295; G06F 40/35; G06F 40/58; G06Q 20/38; G06Q 30/018; G06Q 30/0601

(52) U.S. Cl. CPC G06Q 30/08; G06F 40/295; G06F 40/35; G06F 40/58; G06Q 20/3823; G06Q 30/0185; G06Q 30/0641

(57) ABSTRACT

The present invention provides an AI-driven real-time auction system for live events, integrating dynamic pricing, sentiment analysis, fraud detection and personalized recommendations. The system enables users to bid on event-specific memorabilia through an User Interface module, with a backend architecture utilizing microservices for scalability. AI-driven sentiment analysis adjusts bid increments based on audience excitement, while dynamic pricing module optimize auction value. Fraud detection employs machine learning and blockchain-based logging to ensure bid integrity. Multi-language support and AI-generated storytelling enhance global engagement. Secure payment processing and post-auction analytics provide seamless transaction management and user insights. By leveraging AI automation, the system maximizes auction participation, enhances user experience and optimizes revenue generation for event organizers and venues.

### TECHNICAL FIELD

The present invention relates to AI-driven real-time auction systems for live events, integrating dynamic pricing, sentiment analysis, fraud detection and venue hardware for seamless user engagement and secures transactions.

### BACKGROUND OF THE INVENTION

Live event auctions, particularly for memorabilia such as player-worn merchandise, VIP experiences and exclusive collectibles, have traditionally been conducted through manual or semi-automated processes. The auctions typically rely on physical auctioneers, fixed pricing models or basic online platforms with limited interactivity. The success of such auctions largely depends on audience participation, effective pricing strategies and secure transaction handling. However, traditional auction models often struggle to sustain excitement, dynamically adjust pricing and implement robust fraud prevention mechanisms.

Currently, most auction platforms employ simple online bidding systems or mobile applications with predetermined bid increments. Some platforms incorporate algorithm-based price adjustments, but these lack the flexibility to respond to real-time audience engagement. Sentiment analysis, if used at all, is limited to basic text-based reviews rather than dynamic inputs from live audiences. Furthermore, fraud detection mechanisms in existing systems primarily rely on rule-based filtering, which is inadequate against sophisticated tactics such as bot-driven bidding or multi-account exploitation. Additionally, payment security is typically handled through centralized databases, increasing the risk of bid tampering and unauthorized access.

Despite advancements in digital auctions, existing solutions suffer from several key limitations. Most platforms use static pricing models with fixed or linear bid increments, failing to adjust dynamically based on demand or audience excitement. They also lack real-time sentiment analysis capabilities that could leverage social media activity, live speech analysis and facial expression recognition to optimize auction strategies. Fraud detection remains inefficient, as conventional methods cannot effectively prevent rapid bid spamming, coordinated manipulation or bot-based interference. Furthermore, language barriers prevent international users from participating seamlessly, as most platforms lack real-time AI-driven translation. Finally, post-auction engagement remains underdeveloped, with limited AI-driven strategies for personalized upselling or user retention.

There is a need to address these shortcomings by integrating AI-driven real-time sentiment analysis, dynamic pricing, advanced fraud detection, multilingual support and personalized auction engagement.

### OBJECTS OF THE INVENTION

The primary object of the invention is to enhance live event auctions using AI-driven technologies for engagement, pricing optimization, fraud prevention and secure transactions.

Another object of the invention is to implement real-time sentiment analysis through Natural Language Processing (NLP), speech recognition and computer vision to adjust bid prices dynamically.

Yet another object is to develop a dynamic pricing module that optimizes bid increments based on historical trends, real-time sentiment and bidder behavior.

Yet another object is to strengthen fraud detection using AI-based anomaly detection and blockchain transaction logging for bid security and transparency.

Yet another object is to integrate AI-powered multilingual support for real-time translation, enabling seamless participation for international users.

Yet another objective is to improve post-auction engagement with AI-driven upselling strategies and personalized recommendations for non-winning participants.

Yet another object of the invention is to provide venue administrators with AI-powered analytics on user behavior, bidding trends and auction performance.

Yet another objective is to ensure scalability, security and efficiency through a microservices-based architecture and decentralized transaction logging.

### SUMMARY OF THE INVENTION

The present invention provides an AI-driven real-time auction system for live events, integrating dynamic pricing, sentiment analysis, fraud detection and personalized recommendations. The system enables users to participate in exclusive auctions for event-specific memorabilia, such as player-worn merchandise or backstage passes, through an User Interface module. A microservices-based backend architecture ensures scalability and seamless integration with venue systems, while a secure API gateway and decentralized transaction logging enable tamper-proof execution. The User Interface module facilitates user registration, auction browsing, real-time bidding and AI-powered recommendations, enhancing engagement and user experience.

According to an embodiment of the present invention, an AI-driven sentiment analysis, which continuously monitors audience reactions using natural language processing (NLP) on live social media discussions, speech analysis of crowd excitement and computer vision-based facial expression recognition. The real-time sentiment insights allow dynamic pricing adjustments, optimizing bid increments based on audience enthusiasm and demand. Reinforcement learning algorithms further enhance pricing strategies, ensuring maximum engagement and revenue generation for event organizers.

According to an embodiment of the present invention, a dynamic pricing module that adjusts bid prices based on demand, competitive market analysis and user-specific engagement patterns. AI algorithms leverage historical auction data, bidder behavior and sentiment analysis to determine optimal starting prices and incremental bid adjustments. Personalized bid recommendations are generated using machine learning techniques such as XGBoost and Google AutoML, encouraging active participation while preventing price stagnation.

According to an embodiment of the present invention, the system incorporates AI-based fraud detection using anomaly detection module, including autoencoders and isolation forests. The module identify suspicious activities such as rapid bid placements, multi-account exploitation and bot-generated bids. Additionally, blockchain-based transaction logging ensures an immutable record of auction activities, while multi-factor authentication and encrypted bidding mechanisms enhance security and transparency.

According to an embodiment of the present invention, the system integrates AI-driven storytelling and dynamic ad targeting to enhance user engagement. Named Entity Recognition (NER) extracts details such as player names, event significance and product attributes to create compelling auction narratives, displayed via text-to-VR overlays on venue screens and mobile apps. AI-powered ad targeting recommends related memorabilia based on user interests and engagement levels, increasing auction participation.

According to an embodiment of the present invention, the system incorporates multi-language support with real-time AI translation. AI translation APIs such as OpenAI Whisper and MarianMT provide instant transcription and translation of auction-related content, ensuring seamless communication for international participants. The multi-language support with real-time AI translation broadens the reach of live event auctions, enabling global audience engagement without language barriers.

According to an embodiment of the present invention, the system enhances post-auction engagement through AI-driven personalized recommendations. Winning bidders receive secure payment processing notifications, while non-winning participants are provided with tailored upselling offers for alternative memorabilia and future event auctions. Post-auction analytics offer venue administrators insights into audience behavior, bidding trends and revenue performance, enabling continuous optimization of auction strategies.

According to an embodiment of the present invention, the User Interface module enhances real-time user interaction by providing push notifications with personalized bidding suggestions. The backend employs an event-driven architecture, integrating advanced NLP module such as BERT and GPT-4 for sentiment analysis. The fraud detection module uses autoencoder-based anomaly detection to prevent unfair bidding practices. Additionally, NFC/RFID integration ensures authenticity verification for auctioned memorabilia.

According to an embodiment of the present invention, the auction system supports API integration with venue management systems, enabling automated auction scheduling and real-time display synchronization. IoT sensors track player-worn merchandise, ensuring auction eligibility and authentication. Secure payment processing is enforced through AES-256 encryption, OAuth 2.0 authentication and blockchain-based bid verification, maintaining transaction integrity and user trust.

The method for conducting AI-driven real-time auctions during live events begins with user registration, where users create profiles and specify event preferences via the User Interface module. Venue administrators configure event-specific auctions by linking memorabilia to the live event. Once an auction is initiated, items are displayed on venue screens and mobile devices, allowing users to place real-time bids. AI module analyze audience sentiment through NLP, speech analysis and facial recognition to dynamically adjust pricing, optimize bid increments and enhance engagement. Reinforcement learning algorithms refine bid pricing based on historical trends, real-time excitement levels and market demand.

According to an embodiment of the present invention, the method incorporates fraud detection using AI-powered anomaly detection module and blockchain-based bid logging. The system supports multi-language translation using AI-driven NLP module, ensuring seamless participation for international users. AI-generated storytelling modules create engaging narratives about auctioned items, displayed on mobile apps and venue screens. Secure payment processing is conducted using encrypted transactions, multi-factor authentication and blockchain-based bid verification.

According to an embodiment of the present invention, post-auction engagement strategies notify winning bidders for payment processing while providing non-winning participants with alternative memorabilia offers and invitations to future auctions. AI-driven analytics provide event organizers with insights into bidding trends, audience engagement and revenue performance, enabling continuous optimization of auction strategies. The method ensures seamless interaction between users, venues and auction systems, maximizing participation, engagement and revenue generation at live events.

These and other aspects of the embodiments herein will be better appreciated and understood when considered in conjunction with the following description and the accompanying drawings. It should be understood, however, that the following descriptions, while indicating the preferred embodiments and numerous specific details thereof, are given by way of illustration and not of limitation. Many changes and modifications may be made within the scope of the embodiments herein without departing from the spirit thereof and the embodiments herein include all such modifications.

### BRIEF DESCRIPTION OF THE DRAWINGS

The other objects, features and advantages will occur to those skilled in the art from the following description of the preferred embodiment and the accompanying drawings in which:

FIG. 1 illustrates the system architecture of the AI-driven real-time auction system for live events with dynamic pricing, sentiment analysis and fraud detection, according to the present invention.

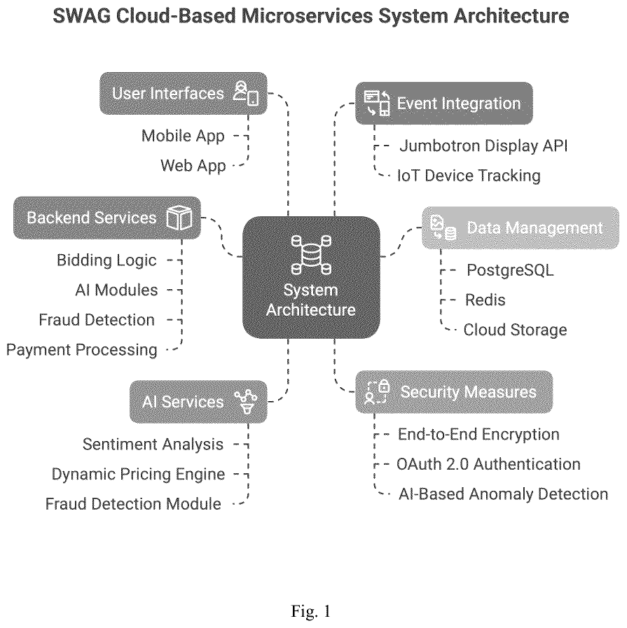

FIG. 2 illustrates a flowchart for sentiment analysis and dynamic pricing of the AI-driven real-time auction system for live events with dynamic pricing, sentiment analysis and fraud detection, according to the present invention.

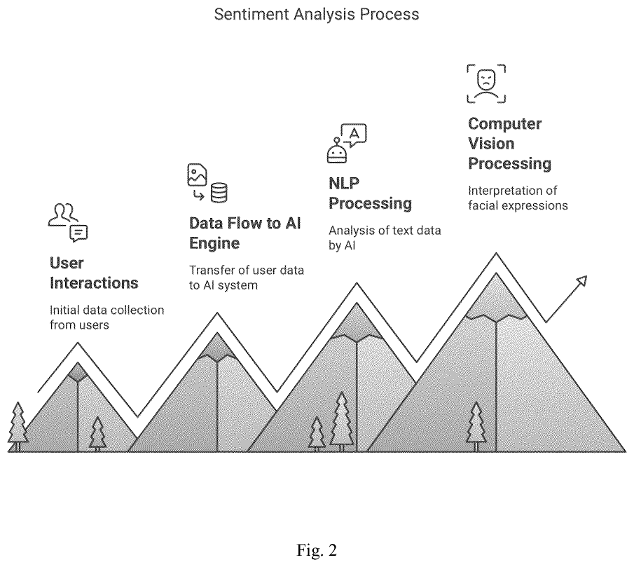

Although the specific features of the present invention are shown in some drawings and not in others. This is done for convenience only as each feature may be combined with any or all of the other features in accordance with the present invention.

### DETAILED DESCRIPTION OF THE INVENTION

In the following detailed description, a reference is made to the accompanying drawings that form a part hereof and in which the specific embodiments that may be practised are shown by way of illustration. These embodiments are described in sufficient detail to enable those skilled in the art to practice the embodiments and it is to be understood that other changes may be made without departing from the scope of the embodiments. The following detailed description is therefore not to be taken in a limiting sense. The various embodiments of the present invention provide for an AI-driven real-time auction system for live events that integrates dynamic pricing, sentiment analysis, fraud detection and personalized recommendations to enhance engagement and maximize revenue.

The system is designed to support real-time auctions during live events by leveraging AI-driven analytics, dynamic pricing, sentiment analysis and fraud detection. Its architecture follows a microservices-based approach with modular AI components, ensuring scalability and seamless integration with venue systems. The system consists of several key components, including the User Interface (UI), the Server, AI Modules, Database & Storage, Venue & Hardware Integration and Security & Fraud Detection. Each of the components delivers an interactive and optimized auction experience.

According to an embodiment of the present invention, the User Interface (UI) is designed as a multi-platform application available on iOS android and web. It provides users with access to ongoing auctions, real-time bidding functionality, personalized recommendations and multi-language support. The server is responsible for handling API requests, managing microservices for AI-driven functionalities and ensuring secure and efficient storage of transaction and auction data. With an event-driven architecture, the server seamlessly facilitates real-time interactions between the app, venues and audience devices.

According to an embodiment of the present invention, the AI Modules are central to the system's ability to enhance user engagement and optimize auctions. The Sentiment Analysis Engine detects audience emotions to adjust auction strategies dynamically. The Dynamic Pricing Module continuously updates bid prices based on real-time market conditions, audience engagement and demand. A Fraud Detection module prevents malicious activities, ensuring fair and transparent bidding. The Personalized Recommendation Engine enhances user experience by tailoring auction suggestions based on bidding history and preferences. Additionally, the AI-driven Ad Targeting & Storytelling Module creates engaging narratives around auctioned items to increase user participation.

According to an embodiment of the present invention, the system's Database & Storage infrastructure supports large-scale operations. Transactional data is managed using BigQuery or PostgreSQL, while Redis or Firestore handles real-time bidding states. Cloud storage solutions like GCP or AWS S3 are used to store auction-related multimedia, including images, videos and live auction feeds. The architecture ensures that the system can efficiently process high volumes of transactions and provide real-time updates to users and venue administrators.

According to an embodiment of the present invention, Venue & Hardware Integration module functions seamlessly within live event environments. Integration with Jumbotron displays allows real-time auction visuals to be shown at the venue. IoT devices, including RFID and NFC sensors, track player-worn memorabilia and other auction items. Secure payment gateways such as Stripe, PayPal and cryptocurrency wallets facilitate transactions, ensuring a smooth checkout experience. Social media APIs allow real-time sentiment analysis by analyzing audience reactions across platforms like Twitter and Instagram.

According to an embodiment of the present invention, a robust Security & Fraud Detection mechanisms to maintain security and prevent fraudulent activities. AI-driven fraud prevention module detects suspicious bidding patterns and prevents manipulation attempts. OAuth 2.0 and JWT authentication ensure user identity verification, while end-to-end encryption protects financial transactions and sensitive data. Additionally, transaction logging mechanisms maintain an immutable record of all auction activities, ensuring compliance with security standards.

According to an embodiment of the present invention, the system interaction follows a structured workflow that enhances both user experience and operational efficiency. Users register through email, social login or venue ticket authentication. Their preferences and past transactions are analyzed to provide personalized recommendations. Venue administrators configure auctions by linking event-specific memorabilia to the live auction platform. Once an auction starts, AI-driven sentiment analysis continuously monitors audience reactions and dynamically adjusts pricing based on engagement levels. Personalized notifications encourage users to participate in bidding, while fraud detection module ensures fair play. After the auction concludes, winners receive notifications for secure payment processing and non-winners are provided with personalized upselling recommendations. Venue administrators can access analytics dashboards to assess auction performance and audience engagement.

According to an embodiment of the present invention, AI-driven sentiment analysis, which refines auction strategies based on audience reactions. Natural Language Processing (NLP) is employed to analyze real-time audience feedback from social media posts and comments. Computer Vision (CV) enables facial expression recognition to gauge excitement levels from event cameras. Speech Analysis identifies enthusiasm in crowd cheers and live commentary. Reinforcement Learning techniques further optimize pricing adjustments based on collective sentiment trends. The AI-driven methodologies allow the system to create a dynamic and responsive auction experience that adapts to real-time audience behavior.

According to an embodiment of the present invention, Dynamic Pricing Module within the system ensures optimal bid strategies and revenue generation. Demand-based pricing leverages historical auction data and current engagement metrics to determine real-time pricing adjustments. Competitive pricing module analyze market conditions to ensure items are auctioned at competitive rates. Personalized price recommendations tailor bid suggestions based on individual user behavior and bidding history. Reinforcement Learning algorithms dynamically adjust bid increments based on ongoing participation trends, ensuring that auctions remain engaging and profitable. The pricing module is implemented using advanced machine learning frameworks such as Scikit-learn, PyTorch, XGBoost and Google AutoML.

According to an embodiment of the present invention, to ensure integrity and prevent exploitation, AI-driven fraud detection module identifies and mitigates suspicious activities. Pattern recognition techniques detect bid spamming and automated bot participation. Anomaly detection module, including autoencoders, identify unusual bidding behaviors. Blockchain-based transaction logging maintains an immutable record of bid history, preventing tampering and fraudulent claims. Fraudulent activities such as multi-account exploitation, VPN-based identity masking and bot-generated fake bids are detected using AI-powered techniques like TensorFlow Autoencoders, Isolation Forest, Keras Fraud Detection module and Web3-based blockchain verification.

According to an embodiment of the present invention, the multi-language support ensures accessibility for a diverse global audience. Real-time AI translation APIs such as Google Translate and AWS Translate enable seamless multilingual interactions. Live subtitle generation enhances the auction experience by providing language-specific overlays on auction screens. NLP-driven transcription ensures that audience queries and responses are accurately translated into multiple languages in real-time. AI module such as T5, MarianMT and OpenAI Whisper facilitate accurate and efficient multilingual processing, ensuring an inclusive and accessible auction experience.

According to an embodiment of the present invention, the auction lifecycle follows a structured process to maximize engagement and transaction efficiency. Users register on the platform and set their preferences. Auction items are displayed in real time on Jumbotron screens and the User Interface module. AI-driven personalization delivers targeted bidding recommendations, increasing participation. The bidding process is dynamically optimized using AI-driven pricing adjustments and fraud detection module. Upon auction completion, winners receive notifications for secure payment processing, while non-winning participants are provided with tailored offers for related memorabilia.

According to an embodiment of the present invention, to enable seamless venue integration, the system provides API compatibility with Jumbotrons and venue event apps. The venue integration module provides API connectivity to event management module, enabling automated auction scheduling and display synchronization Customization options allow venues to tailor the auction system to various event formats, including sports matches, concerts and industry conventions. The backend dashboard equips venue administrators with real-time analytics, providing insights into auction performance and audience engagement. A module for Hardware integrations such as IoT sensors enables automated tracking of auctioned items, while NFC/RFID technology streamlines event-based checkout experiences.

According to an embodiment of the present invention, the system employs a combination of modern programming languages and frameworks. The backend is built using Python (FastAPI) and Node.js for efficient API handling and microservices management. The frontend is developed using React Native for mobile applications and Next.js for web-based interactions. AI module leverage TensorFlow, PyTorch and OpenAI APIs to deliver real-time analytics and decision-making. PostgreSQL, BigQuery and Redis handle high-speed database operations. The infrastructure is deployed using Kubernetes and Google Cloud Run, ensuring scalability, reliability and minimal latency.

According to an embodiment of the present invention, the system's flow begins when users log into the app and browse available auctions. Real-time auction details are displayed on event Jumbotrons, enabling a synchronized digital and physical auction experience. AI-driven recommendations optimize bidding strategies, dynamically adjusting price increments based on engagement levels. At the conclusion of an auction, the winning bid is processed through a secure payment gateway and fulfillment mechanisms ensure timely item delivery. Post-auction engagement strategies, including upselling and personalized recommendations, encourage ongoing participation in future auctions.

According to an embodiment of the present invention, security and data protection are fundamental to the system's operation. AES-256 end-to-end encryption ensures secure transactions, while compliance with GDPR and CCPA regulations safeguards user data. AI-driven fraud monitoring continuously detects and prevents suspicious activities, ensuring a safe and transparent auction environment. By leveraging AI, microservices architecture and advanced security protocols, the system delivers an innovative, scalable and highly interactive auction platform for live events, transforming the way memorabilia and exclusive event experiences are auctioned in real time.

According to an embodiment of the present invention, the method for conducting AI-driven real-time auctions during live events incorporates several novel and inventive features, including real-time sentiment analysis, dynamic pricing, fraud detection, personalized recommendations and multilingual support. The method enables seamless user interaction through an User Interface module, where participants can browse auction items, place real-time bids and receive AI-driven bid recommendations. Sentiment analysis utilizes natural language processing (NLP) for social media discussions, speech analysis for live audience reactions and computer vision-based facial recognition to assess engagement levels. The system dynamically adjusts bid increments using reinforcement learning algorithms based on demand, excitement and historical auction trends. Fraud detection module leverage AI-based anomaly detection module, including autoencoders and isolation forests, while blockchain-based transaction logging ensures bid security and transparency. Additionally, the method incorporates real-time AI translation for multilingual accessibility, AI-generated storytelling for auction engagement and secure payment processing through encrypted transactions and authentication protocols.

According to an embodiment of the present invention, the method begins with user registration via the User Interface module, where participants create profiles and specify event preferences. Venue administrators configure event-specific auctions by linking memorabilia, such as player-worn items or exclusive backstage passes, to a scheduled event. The auction is initiated and displayed on venue screens and mobile devices, enabling participants to browse, receive AI-driven recommendations and place bids in real time.

According to an embodiment of the present invention, during the auction, the system continuously analyzes sentiment data extracted from social media posts, crowd reactions and facial expressions to assess engagement levels. Using reinforcement learning, the AI module optimizes bid increments and adjusts pricing dynamically to maintain competitive and engaging bidding activity. Personalized bid suggestions are generated based on user engagement patterns, past purchases and real-time sentiment indicators, encouraging higher participation and strategic bidding.

According to an embodiment of the present invention, to ensure fairness, the fraud detection module monitors bidding activities for anomalies such as rapid bidding, bid spamming and multi-account exploitation. AI-driven anomaly detection module identify irregularities, while blockchain technology provides an immutable record of all bid transactions, preventing tampering and unauthorized modifications. Multi-factor authentication and bid encryption further secure the auction process.

According to an embodiment of the present invention, upon conclusion of the auction, winning bidders are notified and directed to a secure payment gateway for transaction processing. Non-winning participants receive personalized recommendations for alternative memorabilia and future auction opportunities, increasing engagement beyond the live event. The system also provides venue administrators with detailed analytics on auction performance, user engagement and revenue trends, allowing continuous optimization of future auctions. Through AI-driven automation, real-time analysis and secure transactions, the method revolutionizes live event auctions, enhancing user experience, ensuring auction integrity and maximizing revenue generation for event organizers.

The foregoing description of the specific embodiments will so fully reveal the general nature of the embodiments herein that others can, by applying current knowledge, readily modify and/or adapt for various applications such as specific embodiments without departing from the generic concept and, therefore, such adaptations and modifications should and are intended to be comprehended within the meaning and range of equivalents of the disclosed embodiments.

It is to be understood that the phraseology or terminology employed herein is for the purpose of description and not of limitation. Therefore, while the embodiments herein have been described in terms of preferred embodiments, those skilled in the art will recognize that the embodiments herein can be practiced with modifications. However, all such modifications are deemed to be within the scope of the claim.

1. A system for conducting AI-driven real-time auctions during live events, the system comprising:
an User Interface module configured to facilitate user registration, bid placement and personalized recommendations;
a server comprising an API gateway and microservices for handling real-time auction processing, AI module execution and database management;
an AI-driven sentiment analysis engine configured to extract real-time emotional data from social media, live audience speech and facial expressions;
a dynamic pricing module integrated with AI algorithms to adjust bid pricing based on demand, sentiment analysis and historical auction data;
a fraud detection module utilizing anomaly detection module and blockchain-based transaction logging for bid security;
a multi-language support module leveraging AI-based translation module for real-time translation of auction-related messages;
an AI-generated storytelling module configured to create narratives around auction items to enhance engagement;
a venue integration module enabling auction visualization on venue screens via a Jumbotron display API;
a hardware integration module comprising IoT sensors and NFC/RFID technology for tracking event-related merchandise; and
a secure payment and authentication module employing encryption and authentication protocols for bid processing and transaction security.

2. The system as claimed in claim 1, wherein the User Interface module includes real-time push notifications to deliver personalized bidding recommendations and engagement prompts.

3. The system as claimed in claim 1, wherein the server utilizes an event-driven architecture to process auction events and ensure seamless real-time interactions.

4. The system as claimed in claim 1, wherein the AI-driven sentiment analysis engine employs NLP module such as BERT, GPT-4 and Hugging Face Transformers for textual analysis of audience responses.

5. The system as claimed in claim 1, wherein the fraud detection module implements autoencoder-based anomaly detection module to identify suspicious bidding behavior.

6. The system as claimed in claim 1, wherein the multi-language support module integrates AI-powered translation APIs such as Google Translate API, AWS Translate or OpenAI Whisper.

7. The system as claimed in claim 1, wherein the AI-generated storytelling module applies named entity recognition techniques to extract key event details and generate personalized auction item descriptions.

8. The system as claimed in claim 1, wherein the venue integration module provides API connectivity to event management module, enabling automated auction scheduling and display synchronization.

9. The system as claimed in claim 1, wherein the IoT sensors track player-worn merchandise and authenticate its auction eligibility using NFC/RFID technology.

10. The system as claimed in claim 1, wherein the secure payment and authentication module implements AES-256 encryption, OAuth 2.0 and blockchain-based bid verification to ensure transaction integrity.

11. A method for conducting AI-driven real-time auctions during live events, the method comprising:
receiving user registration data and event-specific preferences via an User Interface module;
initiating an auction for event-related merchandise by displaying auction items on venue screens and mobile devices;
collecting real-time audience sentiment data through natural language processing (NLP) of social media activity, speech analysis of live audience reactions and computer vision-based facial emotion recognition;
dynamically adjusting auction pricing using AI-based module that analyze demand, sentiment data, historical auction results and real-time engagement levels;
providing personalized bid recommendations based on pre-auction user preferences, real-time excitement levels and past bidding behavior;
detecting fraudulent bidding patterns using AI-based anomaly detection algorithms and blockchain-based bid logging;
supporting multi-language real-time translation of auction-related communications using AI-based translation module;
delivering AI-generated storytelling narratives for auction items to enhance user engagement and bidding enthusiasm;
processing and securing winning bids through end-to-end encryption and authentication mechanisms; and
providing post-auction engagement by offering personalized recommendations to non-winning participants.

12. The method as claimed in claim 11, wherein the sentiment data is derived from at least one of social media text analysis, live audience speech sentiment and facial emotion recognition.

13. The method as claimed in claim 11, wherein the dynamic pricing module uses reinforcement learning to optimize bid increments based on historical auction trends and real-time user engagement.

14. The method as claimed in claim 11, wherein fraud detection is performed using machine learning-based anomaly detection module including autoencoders and isolation forests.

15. The method as claimed in claim 11, wherein the AI-generated storytelling module utilizes named entity recognition to extract and highlight key product details, event significance and user-specific emotional triggers.

16. The method as claimed in claim 11, wherein the AI-driven ad targeting module identifies comparable memorabilia and suggests related auction items based on previous purchases and bidding behavior.

17. The method as claimed in claim 11, wherein real-time translation is performed using NLP-based module such as T5, MarianMT or OpenAI Whisper to ensure seamless communication among multi-lingual participants.

18. The method as claimed in claim 11, wherein the auction process is visually enhanced using text-to-VR overlays that summarize auction item details in real time on venue screens.

19. The method as claimed in claim 11, wherein user engagement is further increased through gamification by offering bid range optimizations, upselling opportunities and VIP access to event-related activities.

20. The method as claimed in claim 11, wherein non-winning participants receive Al-generated post-auction engagement messages offering alternative memorabilia and future auction invitations.
